(19) United States
(12) Patent Application Publication
(10) Pub. No.: US 2021/0272111 A1
(43) Pub. Date: Sep. 2, 2021

(54) Multi-Chain Concurrent Transaction Method

(71) Applicant: JIANGSU FUZAMEI TECHNOLOGY CO.,LTD., SUZHOU (CN)

(72) Inventors: Sijin WU, SUZHOU (CN); Zhiwen WANG, SUZHOU (CN)

(21) Appl. No.: 17/256,622

(22) PCT Filed: Jun. 20, 2019
(86) PCT No.: PCT/CN2019/092157

§ 371 Date: Dec. 28, 2020

(30) Foreign Application Priority Data
Jun. 28, 2018 (CN) 201810691265.9

(51) Int. Cl. G06Q 20/38; G06Q 20/10

(52) U.S. Cl. CPC G06Q 20/3829; G06Q 2220/00; G06Q 20/102

(57) ABSTRACT

The present invention provides a multi-chain concurrent transaction method, including the following steps. The cross-chain transaction information sent by a user through a user terminal is received; the cross-chain transaction information is distributed to the accounting node and the consensus node of the corresponding main chain or sub-chain according to the payer address of the cross-chain transaction information, so that the accounting node of each main chain or sub-chain performs multi-chain concurrent transaction, so that the main chain or sub-chain does not occupy a large amount of bandwidth while obtaining cross-chain transaction information, and the performance of the blockchain network is guaranteed.

### BACKGROUND OF THE PRESENT INVENTION

### Field of Invention

The present invention relates to the technical field of blockchain, and in particular, to a multi-chain concurrent transaction method.

### Description of Related Arts

Aiming at the issues of long waiting time, excessive waste of resources, serious surplus of CPU resources and the like in the original block chain packaging transaction information method, the block chain network is divided into one main chain and multiple sub-chains, and the transaction information is distributed to parallel packaging on different chains for resolution. The user is provided with an account address on the main chain and each sub-chain that using the main chain as an example, the main chain needs to monitor other sub-chains in real time, and when a new block is generated, the block heads need to be synchronized from other sub-chains to obtain cross-chain transaction information, so that when the account address balance of the main chain is insufficient, the balance of the account addresses on the other sub-chains can be called for payment; and when the number of the sub-chains is large, mutual monitoring between different chains acquires cross-chain transaction information, which will occupy a large amount of bandwidth and seriously affect the performance of the blockchain network.

In summary, it is currently necessary to provide a technical solution that enables the main chain or the sub-chain to not occupy a large amount of bandwidth while obtaining cross-chain transaction information, thereby ensuring the performance of the blockchain network.

### SUMMARY OF THE PRESENT INVENTION

In view of the above, the present invention provides a multi-chain concurrent transaction method that addresses or partially addresses the above-mentioned issues.

In a first aspect, the present invention provides a multi-chain concurrent transaction method, including:

receiving cross-chain transaction information sent by a user through a user terminal;

distributing the cross-chain transaction information to the accounting node and the consensus node of the corresponding main chain or sub-chain according to the payer address of the cross-chain transaction information, so that the accounting node of each main chain or sub-chain performs the following steps:

deducting an asset corresponding to a corresponding amount on the first payer address according to the cross-chain transaction information, and assigning an index for the corresponding cross-chain transaction information, wherein the first payer address is a payment address of the payer on a main chain or a sub-chain;

packing the cross-chain transaction information on the main chain or sub-chain to generate a first block header information, so as to allow the consensus node on the central chain to verify the correctness of the cross-chain transaction information through synchronizing the first block header information: if correct, generating a corresponding amount of asset on the second payer address, transferring the corresponding amount of asset from the second payer address to the second payee address, and writing the cross-chain transaction information configured with the index to the central chain, wherein the second payee address is the payee address of the payee at the central chain;

receiving, from a central chain, deduction information of an asset corresponding to a corresponding amount on the second payee address, and after the synchronization of the index and the signature information of the cross-chain transaction information on center chain, generating a corresponding amount of assets on the first payee address, wherein the first payee address is a collection address on a main chain or a sub-chain of the payee;

packing the cross-chain transaction information on the main chain or sub-chain to generate a second block header information for a consensus node on the central chain to obtain transaction completion information of the cross-chain transaction information through synchronizing the second block header information, and recording the cross-chain transaction information on the central chain.

In a second aspect, the present invention also provides a multi-chain concurrent transaction method, including:

receiving the index of the cross-chain transaction information and the cross-chain transaction information that are consented by the main chain or sub-chain;

synchronizing the first block header information, verifying whether the corresponding amount of asset has been correctly deducted from the first payer address:

if correct, generating a corresponding amount of asset on the second payer address, transferring the corresponding amount of asset from the second payer address to the second payee address, and recording the cross-chain transaction information configured with the index;

deducting the deduction information corresponding to the corresponding amount of the asset on the second payee address, and signing the cross-chain transaction information with the private key to generate a corresponding amount of asset on the first payee address after the accounting node of the main chain or sub-chain synchronizes the index and the signature information of the cross-chain transaction information;

synchronizing the second block header information and recording a transaction completion information of the cross-chain transaction information.

In a third aspect, the present invention also provides a device including one or more processors and memories, wherein the memory includes commands executable by the one or more processors to allow the one or more processors to perform the multi-chain concurrent transaction method provided in accordance with the embodiments of the present invention.

In a fourth aspect, the present invention also provides a storage medium storing a computer program that allows a computer to perform the multi-chain concurrent transaction method provided in accordance with the embodiments of the present invention.

The advantages of the present invention includes:

The present invention provides a multi-chain concurrent transaction method, including the following steps. The cross-chain transaction information sent by a user through a user terminal is received; the cross-chain transaction information is distributed to the accounting node and the consensus node of the corresponding main chain or sub-chain according to the payer address of the cross-chain transaction information, so that the accounting node of each main chain or sub-chain performs multi-chain concurrent transaction, so that the main chain or sub-chain does not occupy a large amount of bandwidth while obtaining cross-chain transaction information, and the performance of the blockchain network is guaranteed.

The method of the present invention that respectively configures sub-chain addresses on the sub-chains respectively through the main chain address configured on the main chain, wherein the sub-chain addresses of the same user contain the main chain address, allows a single private key to be used for signing the transaction information of multiple chains at the same time, which provides a great user experience for the user.

The method of the present invention that determines whether the account balance on the corresponding main chain or sub-chain is sufficient for a payment according to the payer address and modifies the payer address accordingly, is capable of further optimizing the user experience.

The method that present invention checks whether the main chain or sub-chain corresponding to the payer address is in a congestion state through checking the conditions of the main chain and each sub-chain through the central chain and modifies the payer address to the address of the payer on the main chain or sub-chain which is currently in the non-congestion state, is capable of reducing the congestion rate of the blockchain network and enhancing the performance of the blockchain network.

According to the present invention, the state of the main chain and each sub-chain is checked through the central chain in order to add or reduce sub-chain, which increases the bandwidth utilization efficiency and further enhances the blockchain network performance.

According to the present invention, the method that generates a cross-chain transaction information for transferring the balance of the sub-chain account of the same user into the main chain account once in a while is capable of implementing periodic account balance aggregation, and further optimizing the user experience.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is a perspective view of the multi-chain concurrent transaction according to a preferred embodiment of the present invention.

FIG. 2 is a flow chart of a multi-chain concurrent transaction method according to a preferred embodiment of the present invention.

FIG. 3 is a flow chart of a preferred implementation of the method of FIG. 2.

FIG. 4 is a flow chart of a preferred implementation of the method of FIG. 2.

FIG. 5 is a flow chart of another multi-chain concurrent transaction method according to a preferred embodiment of the present invention.

FIG. 6 is a schematic view of a device according to a preferred embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

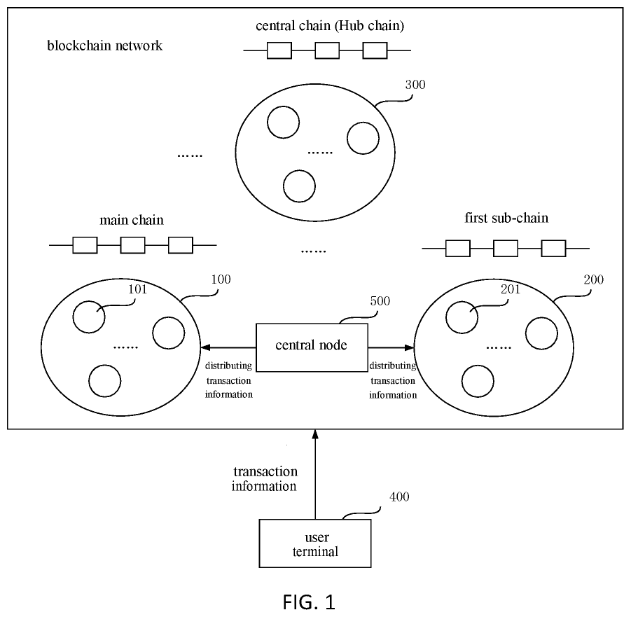

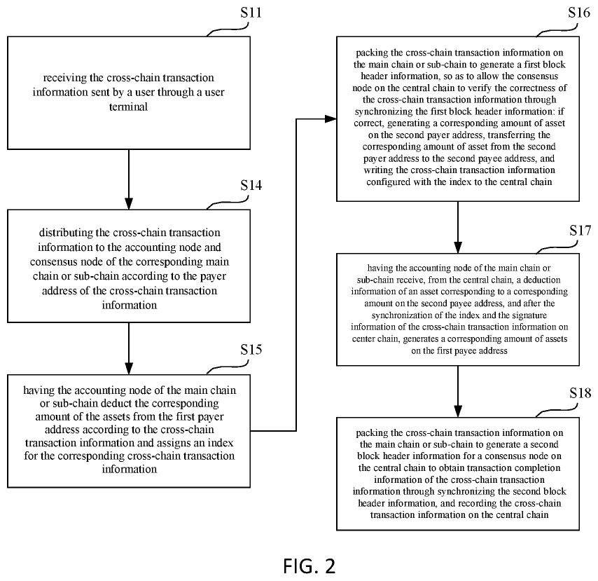

FIG. 1 is a perspective view of the multi-chain concurrent transaction according to a preferred embodiment of the present invention. Referring to FIG. 1, according to the present embodiment, the central chain 300 may provide a cross-chain service for a multi-chain concurrent transaction for a main chain 100 and a first sub-chain 200. The transaction information sent by the user terminal 400 is received by the central node 500, and the transaction information is distributed for the main chain 100 and the first sub-chain 200 according to the payer address of the transaction information. The accounting node 101 of the main chain and the accounting node 201 of the first sub-chain package the transaction information thereof respectively. The cross-chain asset transfer solution provided by the present invention will be described in detail below with FIGS. 2 -6. In more embodiments, the same technical effect can also be achieved by cross-chain transfer of assets on any main chain or sub-chain through the central chain according to actual requirements.

FIG. 2 is a flow chart of a multi-chain concurrent transaction method according to a preferred embodiment of the present invention. Referring to FIG. 2, according to the present embodiment, the present invention provides a cross-chain asset transfer method in a multi-chain concurrent transaction, which including the following steps:

S11: having the central node receiving the cross-chain transaction information sent by a user through a user terminal;

S14: having the central node distributing the cross-chain transaction information to the accounting node and the consensus node of the corresponding main chain or sub-chain according to the payer address of the cross-chain transaction information, so that the accounting node of each main chain or sub-chain performs the following steps:

S15: deducting an asset corresponding to a corresponding amount on the first payer address according to the cross-chain transaction information, and assigning an index for the corresponding cross-chain transaction information, wherein the first payer address is a payment address of the payer on a main chain or a sub-chain;

S16: packing the cross-chain transaction information on the main chain or sub- chain to generate a first block header information, so as to allow the consensus node on the central chain to verify the correctness of the cross-chain transaction information through synchronizing the first block header information: if correct, generating a corresponding amount of asset on the second payer address, transferring the corresponding amount of asset from the second payer address to the second payee address, and writing the cross-chain transaction information configured with the index to the central chain, wherein the second payee address is the payee address of the payee at the central chain;

S17: receiving, from the central chain, a deduction information of an asset corresponding to a corresponding amount on the second payee address, and after the synchronization of the index and the signature information of the cross-chain transaction information on center chain, generating a corresponding amount of assets on the first payee address, wherein the first payee address is a collection address on a main chain or a sub-chain of the payee;

S18: packing the cross-chain transaction information on the main chain or sub-chain to generate a second block header information for a consensus node on the central chain to obtain transaction completion information of the cross-chain transaction information through synchronizing the second block header information, and recording the cross-chain transaction information on the central chain.

Specifically, using the application scenario illustrated in FIG. 1 as an example, it is assumed that at this time, the user A sends the cross-chain transaction information A to the blockchain network through the user terminal 400, and the blockchain network only receives the transaction information before completing the cross-chain transaction information, wherein the cross-chain transaction information A expresses: transferring 10 of some kind of the assets from the primary chain account address of the user A to the first sub-chain account address of the user B;

In the step S11: the central node 500 receives the cross-chain transaction information A sent by a user A through a user terminal 400;

In the step S14: the central node 500 distributes the cross-chain transaction information A to the accounting node 101 and the consensus node of the main chain according to the payer address, so as to allow the accounting node 101 of the main chain to perform the following steps:

In the step S15: the accounting node 101 of the main chain deducts the corresponding amount of assets from the main chain account address of the user A according to the cross-chain transaction information and assigns an index for the cross-chain transaction information A, assuming that the assigned index is 1;

In the step S16: the accounting node 101 of the main chain packages the cross-chain transaction information A of the main chain to generate a first block header information, so as for the consensus node on the central chain to check the correctness of the cross-chain transaction information through synchronizing the first block header information: if correct, generating an asset corresponding to the amount at the central chain account address of the user A, transferring the corresponding amount of asset from a central chain account address of the user A to a central chain account address of the user B, and writing the cross-chain transaction information A with the index of 1 into the central chain;

In the step S17: the accounting node 201 of the first sub-chain receives the deduction information of the asset corresponding to the corresponding amount on the central chain account address of the user B from the central chain, and generates a corresponding amount of assets on the first sub-chain account address of the user B after synchronizing the index and the signature information of the cross-chain transaction information A on the central chain;

S18: the accounting node 201 of the first sub-chain packs the cross-chain transaction information A of the first sub-chain to generate a second block header information for a consensus node on the central chain to obtain transaction completion information of the cross-chain transaction information through synchronizing the second block header information, and recording the cross-chain transaction information A on the central chain.

According to a preferred embodiment, the payer address may be any of the following: the main chain address configured on the main chain and each sub-chain address configured on each sub-chain, wherein the sub-chain addresses of the same user contain the main chain address, so as to allow a single private key to sign the transaction information of multiple chains at the same time.

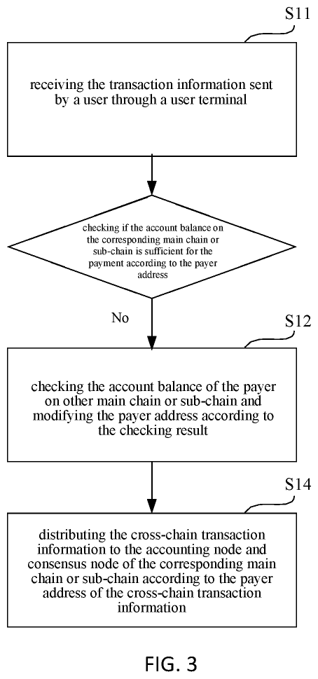

FIG. 3 is a flow chart of a preferred implementation of the method of FIG. 2. Referring to FIG. 3, before distributing the cross-chain transaction information to the accounting node of the corresponding main chain or sub-chain according to the payer address of the cross-chain transaction information, the method further comprises the step of:

S12: having the central node checking if the account balance on the corresponding main chain or sub-chain is sufficient for the payment according to the payer address; if not, checking the account balance of the payer on the other main chain or sub-chain and modifying the payer address according to the check result.

Specifically, using the application scenario illustrated in FIG. 1 as an example, it is assumed that at this time, the user A sends the transaction information B to the blockchain network through the user terminal 400, and the blockchain network only receives the transaction information before completing the transaction information, wherein the transaction information B expresses: transferring 10 of some kind of the assets from the first sub-chain account address of the user A to the first sub-chain account address of the user B, but at this time, the first sub-chain account balance of the user A is insufficient, while the balance of the main chain account of the user A is sufficient;

In the step S11: the central node 500 receives the transaction information B sent by a user A through a user terminal 400;

In the step S12, the central node 500 checks whether the account balance of the first sub-chain account address of the user A is sufficient for the payment according to the payer address. Since the first sub-chain account balance of the user A is insufficient and the main chain account balance of the user A is sufficient, the central node 500 modifies the payer address to the main chain account address of the user A;

In the step S14, the central node 500 assigns and distributes the transaction information B to the accounting node 101 and the consensus node of the main chain according to the payer address of the user A;

The cross-chain transfer principles of the subsequent steps may refer to the method of S15-S18 described above with FIG. 2, which would not be repeated here.

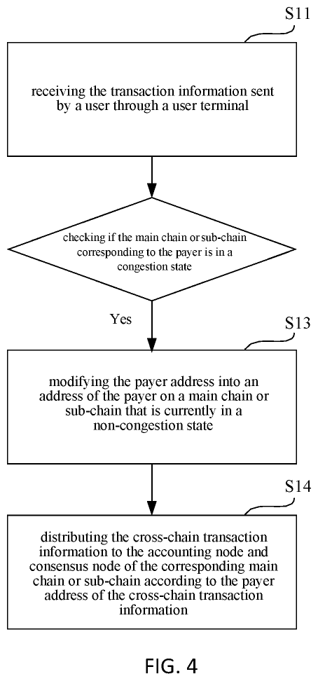

FIG. 4 is a flow chart of a preferred implementation of the method of FIG. 2. The central chain is also utilized for recording the state information of the main chain and each sub-chain. Referring to FIG. 4, before distributing the cross-chain transaction information to the accounting node of the corresponding main chain or sub-chain according to the payer address of the cross-chain transaction information, the method further comprises the step of:

S13: having the central node checking whether the main chain or sub-chain corresponding to the payer address is in a congestion state through checking the conditions of the main chain and each sub-chain through the central chain and: if yes, modifying the payer address to the address of the payer on the main chain or sub-chain which is currently in the non-congestion state.

Specifically, using the application scenario illustrated in FIG. 1 as an example, it is assumed that at this time, the user A sends the transaction information C to the blockchain network through the user terminal 400, and the blockchain network only receives the transaction information before completing the transaction information, wherein the transaction information C expresses: transferring 10 of some kind of the assets from the first sub-chain account address of the user A to the first sub-chain account address of the user B, but at this time, the first sub-chain is in a congestion state, while the main chain is in a non-congestion state;

In the step S11: the central node 500 receives the transaction information C sent by a user A through a user terminal 400;

In the step S13: the central node 500 checks the states of the main chain and each sub-chain through the central chain, and determines whether the main chain or the sub-chains corresponding to the payer address is in a congestion state; since the first sub-chain is in a congestion state and the main chain is in a non-congestion state at this moment, the central node 500 modifies the payer address to the main chain account address of the user A;

In the step S14, the central node 500 assigns and distributes the transaction information C to the accounting node 101 and the consensus node of the main chain according to the payer address of the user A;

The cross-chain transfer principles of the subsequent steps may refer to the method of S15-S18 described above with FIG. 2, which would not be repeated here.

According to a preferred embodiment, the central chain checks the state of the main chain and each of the sub-chains, including the following steps:

if the congestion degree of the main chain and each sub-chain is greater than a first threshold value, adding a sub-chain to relieve the congestion;

if the degree of congestion of the main chain and each sub-chain is less than a second threshold value, reducing the sub-chain to improve the system performance.

According to a preferred embodiment, a cross-chain transaction information is generated to transfer the balance of the sub-chain account of the same user to the main chain account.

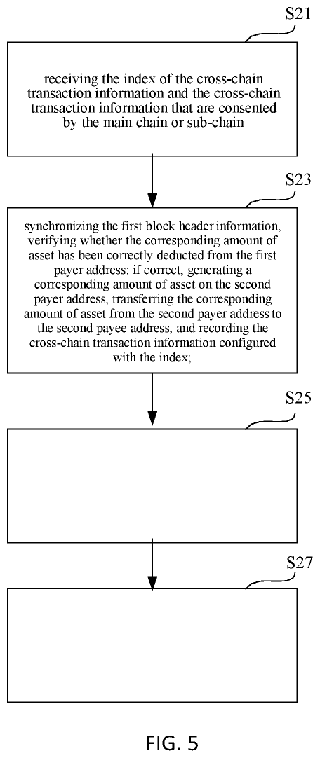

FIG. 5 is a flow chart of another multi-chain concurrent transaction method according to a preferred embodiment of the present invention. Referring to FIG. 5, according to the present embodiment, the present invention provides another cross-chain asset transfer method in a multi-chain concurrent transaction, which including the following steps:

S21: receiving the index of the cross-chain transaction information and the cross-chain transaction information that are consented by the main chain or sub-chain;

S23: synchronizing the first block header information, verifying whether the corresponding amount of asset has been correctly deducted from the first payer address: if correct, generating a corresponding amount of asset on the second payer address, transferring the corresponding amount of asset from the second payer address to the second payee address, and recording the cross-chain transaction information configured with the index;

S25: deducting the deduction information corresponding to the corresponding amount of the asset on the second payee address, and signing the cross-chain transaction information with the private key to generate a corresponding amount of asset on the first payee address after the accounting node of the main chain or sub-chain synchronizes the index and the signature information of the cross-chain transaction information;

S27: synchronizing the second block header information and recording a transaction completion information of the cross-chain transaction information.

Specifically, using the application scenario illustrated in FIG. 1 as an example, it is assumed that at this time, the user A sends the cross-chain transaction information A to the blockchain network through the user terminal 400, and the blockchain network only receives the transaction information before completing the cross-chain transaction information, wherein the cross-chain transaction information A expresses: transferring 10 of some kind of the assets from the primary chain account address of the user A to the first sub-chain account address of the user B;

In the step S21, the central chain 300 receives the cross-chain transaction information A and the index 1 of the cross-chain transaction information that are consented through the main chain;

In the step S23, the central chain 300 synchronizes the first block header information generated by the accounting node 101 of the main chain, and verifies whether the corresponding amount of asset has been correctly deducted from the main chain account address of user A: if yes, the corresponding amount of asset is generated on the central chain account address of the user A, then the corresponding amount of asset is transferred from the central chain account address of the user A to the central chain account address of the user B, and then the cross-chain transaction information A with the index of 1 is recorded;

In the step S25, the central chain 300 deducts the asset corresponding to the corresponding amount on the central chain account address of the user B and signs the cross-chain transaction information A with the private key, so that after the accounting node 201 of the first sub-chain synchronizes the index and the signature information of the cross-chain transaction information A, a corresponding amount of the asset is generated at the first sub-chain account address of the user B;

In the step S27, the central chain 300 synchronizes the second block header information generated by the accounting node 201 of the first sub-chain and records a transaction completion information of the cross-chain transaction information A.

According to a preferred embodiment, the payer address may be any of the following: the main chain address configured on the main chain and each sub-chain address configured on each sub-chain, wherein the sub-chain addresses of the same user contain the main chain address, so as to allow a single private key to sign the transaction information of multiple chains at the same time.

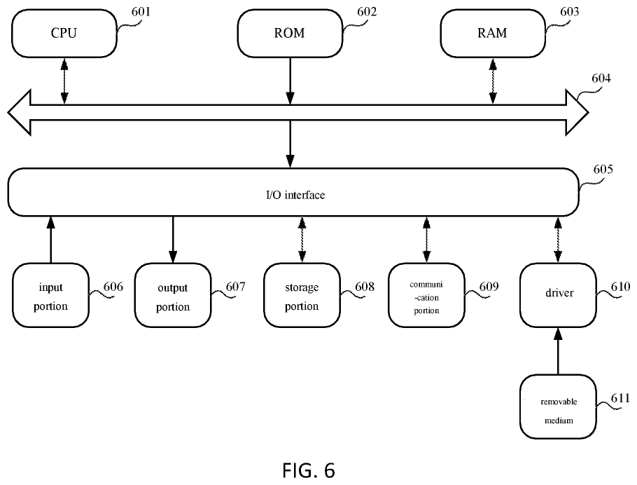

FIG. 6 is a perspective view of a device according to a preferred embodiment of the present invention. Referring to FIG. 6, in another aspect, the present application also provides a device 600, which includes one or more central processing units (CPUs) 601 that can perform various suitable actions and processes in accordance with a program stored in a read-only memory (ROM) 602 or a program loaded into a random access memory (RAM) 603 from a storage portion 608. Various programs and data required for the operation of the device 600 are also stored in the RAM 603. The CPU 601, the ROM 602, and the RAM 603 are connected to each other via a bus 604. An input/output (I/O) interface 1005 is also connected to the bus 604.

The following components are connected to the I/O interface 605: an input portion 606 including a keyboard, a mouse, and etc.; an output portion 607 including a cathode ray tube (CRT), a liquid crystal display (LCD), and etc., and a speaker and etc.; a storage portion 608 including a hard disk or the like; and a communication portion 609 including a network interface card, such as a LAN card, a modem, and etc. The communication portion 609 performs communication process via a network, such as the Internet. A driver 610 is also connected to the I/O interface 605 based on the needs. A removable media 611, such as magnetic disks, optical disks, magneto-optical disks, semiconductor memories, and etc., is mounted on the driver 610 based on the needs so that the computer programs read therefrom can be installed into the storage portion 608 as needed.

In particular, according to the embodiments of the present invention, the multi-chain concurrent transaction method described in any of the above embodiments may be implemented as the computer program. For example, an embodiment of the present invention may provide a computer program product, which includes a computer program tangibly loaded on a machine-readable medium containing program code for performing a multi-chain concurrent transaction method. According to such embodiment, the computer program may be downloaded and installed from the network through the communication portion 609 and/or installed from the removable medium 611.

As yet another aspect, the present application also provides a computer-readable storage medium, which may be a computer-readable storage medium included in a device of the above-described embodiments, or a computer-readable storage medium that may be provided separately, without being assembled in the device. The computer-readable storage medium stores one or more programs that are utilized by one or more processors to perform a multi-chain concurrent transaction method disclosed in the present application.

The flow chart and block diagrams in the figures illustrate the constructions, functionality, and operation of possible implementations of the systems, methods, and computer program products according to various embodiments of the present invention. In this regard, each block in the flow chart or block diagrams may represent a module, segment, or portion of code, which includes one or more executable instructions for implementing the specified logical function (s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the embodiments of the present application may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

1. A multi-chain concurrent transaction method, comprising:
receiving the cross-chain transaction information sent by a user through a user terminal;
distributing the cross-chain transaction information to the accounting node and the consensus node of the corresponding main chain or sub-chain according to the payer address of the cross-chain transaction information, so that the accounting node of each main chain or sub-chain performs the following steps:
deducting an asset corresponding to a corresponding amount on the first payer address according to the cross-chain transaction information, and assigning an index for the corresponding cross-chain transaction information, wherein the first payer address is a payment address of the payer on a main chain or a sub-chain;
packing the cross-chain transaction information on the main chain or sub-chain to generate a first block header information, so as to allow the consensus node on the central chain to verify the correctness of the cross-chain transaction information through synchronizing the first block header information: if correct, generating a corresponding amount of asset on the second payer address, transferring the corresponding amount of asset from the second payer address to the second payee address, and writing the cross-chain transaction information configured with the index to the central chain, wherein the second payer address is the payment address of the payer at the central chain and the second payee address is the payee address of the payee at the central chain;
receiving, from a central chain, deduction information of an asset corresponding to a corresponding amount on the second payee address, and after the synchronization of the index and the signature information of the cross-chain transaction information on center chain, generating a corresponding amount of assets on the first payee address, wherein the first payee address is a collection address on a main chain or a sub-chain of the payee; and
packing the cross-chain transaction information on the main chain or sub-chain to generate a second block header information for a consensus node on the central chain to obtain transaction completion information of the cross-chain transaction information through synchronizing the second block header information, and recording the cross-chain transaction information on the central chain.

2. The multi-chain concurrent transaction method, as recited in claim 1, wherein the payer address is any one of: a main chain address configured on the main chain and each sub-chain address configured on each of the sub-chains respectively, wherein the sub-chain addresses of the same user include the main chain address.

3. The multi-chain concurrent transaction method, as recited in claim 1, before distributing the cross-chain transaction information to the accounting node of the corresponding main chain or sub-chain according to the payer address of the cross-chain transaction information, further comprising:
checking if the account balance on the corresponding main chain or sub-chain is sufficient for the payment according to the payer address; if not, checking the account balance of the payer on the other main chain or sub-chain and modifying the payer address according to the check result.

4. The multi-chain concurrent transaction method, as recited in claim 1, wherein the central chain is further configured to record state information of the main chain and each sub-chain, wherein
before distributing the cross-chain transaction information to the accounting node of the corresponding main chain or sub-chain according to the payer address of the cross-chain transaction information, the method further comprises the step of:
checking whether the main chain or sub-chain corresponding to the payer address is in a congestion state through checking the conditions of the main chain and each sub-chain through the central chain and: if yes, modifying the payer address to the address of the payer on the main chain or sub-chain which is currently in the non-congestion state.

5. The multi-chain concurrent transaction method, as recited in claim 4, further comprising:
checking the state of the main chain and each sub-chain through the central chain:
if the congestion degree of the main chain and each sub-chain is greater than a first threshold value, adding a sub-chain to relieve the congestion;
if the degree of congestion of the main chain and each sub-chain is less than a second threshold value, reducing the sub-chain to improve the system performance.

6. The multi-chain concurrent transaction method, as recited in claim 1, further comprising:
generating a cross-chain transaction information to transfer the balance of the sub-chain account of the same user to the main chain account.

7. A multi-chain concurrent transaction method, comprising:
receiving the index of the cross-chain transaction information and the cross-chain transaction information that are consented by the main chain or sub-chain;
synchronizing the first block header information, verifying whether the corresponding amount of asset has been correctly deducted from the first payer address: if correct, generating a corresponding amount of asset on the second payer address, transferring the corresponding amount of asset from the second payer address to the second payee address, and recording the cross-chain transaction information configured with the index;
deducting the deduction information corresponding to the corresponding amount of the asset on the second payee address, and signing the cross-chain transaction information with the private key to generate a corresponding amount of asset on the first payee address after the accounting node of the main chain or sub-chain synchronizes the index and the signature information of the cross-chain transaction information; and
synchronizing the second block header information and recording a transaction completion information of the cross-chain transaction information.

8. The multi-chain concurrent transaction method, as recited in claim 7, wherein the first payer address and the second payer address are selected from the group consisting of: a main chain address configured on the main chain and each sub-chain address configured on each of the sub-chains respectively, wherein the sub-chain addresses of the same user include the main chain address.

9. A multi-chain concurrent transaction device, comprising:
one or more processors;
a storage medium, adapted for storing one or more programs,
when said one or more processors processing said one or more programs, said one or more processors processing a multi-chain concurrent transaction method.

10. The multi-chain concurrent transaction device, as recited in claim 9, wherein the multi-chain concurrent transaction method comprises:
receiving the cross-chain transaction information sent by a user through a user terminal;
distributing the cross-chain transaction information to the accounting node and the consensus node of the corresponding main chain or sub-chain according to the payer address of the cross-chain transaction information, so that the accounting node of each main chain or sub-chain performs the following steps:
deducting an asset corresponding to a corresponding amount on the first payer address according to the cross-chain transaction information, and assigning an index for the corresponding cross-chain transaction information, wherein the first payer address is a payment address of the payer on a main chain or a sub-chain;
packing the cross-chain transaction information on the main chain or sub-chain to generate a first block header information, so as to allow the consensus node on the central chain to verify the correctness of the cross-chain transaction information through synchronizing the first block header information: if correct, generating a corresponding amount of asset on the second payer address, transferring the corresponding amount of asset from the second payer address to the second payee address, and writing the cross-chain transaction information configured with the index to the central chain, wherein the second payer address is the payment address of the payer at the central chain and the second payee address is the payee address of the payee at the central chain;
receiving, from a central chain, deduction information of an asset corresponding to a corresponding amount on the second payee address, and after the synchronization of the index and the signature information of the cross-chain transaction information on center chain, generating a corresponding amount of assets on the first payee address wherein the first payee address is a collection address on a main chain or a sub-chain of the payee; and
packing the cross-chain transaction information on the main chain or sub-chain to generate a second block header information for a consensus node on the central chain to obtain transaction completion information of the cross-chain transaction information through synchronizing the second block header information, and recording the cross-chain transaction information on the central chain.

11. The multi-chain concurrent transaction device, as recited in claim 9, wherein the payer address is any one of: a main chain address configured on the main chain and each sub-chain address configured on each of the sub-chains respectively, wherein the sub-chain addresses of the same user include the main chain address.

12. The multi-chain concurrent transaction device, as recited in claim 10, wherein before distributing the cross-chain transaction information to the accounting node of the corresponding main chain or sub-chain according to the payer address of the cross-chain transaction information, the multi-chain concurrent transaction method further comprises:
checking if the account balance on the corresponding main chain or sub-chain is sufficient for the payment according to the payer address; if not, checking the account balance of the payer on the other main chain or sub-chain and modifying the payer address according to the check result.

13. The multi-chain concurrent transaction device, as recited in claim 10, wherein the central chain is further configured to record state information of the main chain and each sub-chain, wherein
before distributing the cross-chain transaction information to the accounting node of the corresponding main chain or sub-chain according to the payer address of the cross-chain transaction information, the method further comprises the step of:
checking whether the main chain or sub-chain corresponding to the payer address is in a congestion state through checking the conditions of the main chain and each sub-chain through the central chain and: if yes, modifying the payer address to the address of the payer on the main chain or sub-chain which is currently in the non-congestion state.

14. The multi-chain concurrent transaction device, as recited in claim 13, wherein the multi-chain concurrent transaction method further comprises:
checking the state of the main chain and each sub-chain through the central chain:
if the congestion degree of the main chain and each sub-chain is greater than a first threshold value, adding a sub-chain to relieve the congestion;
if the degree of congestion of the main chain and each sub-chain is less than a second threshold value, reducing the sub-chain to improve the system performance.

15. The multi-chain concurrent transaction device, as recited in claim 10, wherein the multi-chain concurrent transaction method further comprises:
generating a cross-chain transaction information to transfer the balance of the sub-chain account of the same user to the main chain account.

16. The multi-chain concurrent transaction device, as recited in claim 9, wherein the multi-chain concurrent transaction method comprises:
receiving the index of the cross-chain transaction information and the cross-chain transaction information that are consented by the main chain or sub-chain;
synchronizing the first block header information, verifying whether the corresponding amount of asset has been correctly deducted from the first payer address: if correct, generating a corresponding amount of asset on the second payer address, transferring the corresponding amount of asset from the second payer address to the second payee address, and recording the cross-chain transaction information configured with the index;
deducting the deduction information corresponding to the corresponding amount of the asset on the second payee address, and signing the cross-chain transaction information with the private key to generate a corresponding amount of asset on the first payee address after the accounting node of the main chain or sub-chain synchronizes the index and the signature information of the cross-chain transaction information; and
synchronizing the second block header information and recording a transaction completion information of the cross-chain transaction information.

17. The multi-chain concurrent transaction device, as recited in claim 16, wherein the first payer address and the second payer address are selected from the group consisting of a main chain address configured on the main chain and each sub-chain address configured on each of the sub-chains respectively, wherein the sub-chain addresses of the same user include the main chain address.
